(19) United States
(12) Patent Application Publication
(10) Pub. No.: US 2026/0185874 A1
(43) Pub. Date: Jul. 2, 2026

(54) HAND-HELD DEVICE FOR SPECTROPHOTOMETRY

(71) Applicant: BASF COATINGS GMBH, Muenster (DE)

(72) Inventors: William BIERIE, Whitehouse, OH (US); Magdalene HOELTKE, Steinfurt (DE)

(21) Appl. No.: 19/133,097

(22) PCT Filed: Nov. 30, 2023
(86) PCT No.: PCT/EP2023/083634

§ 371 Date: May 27, 2025

(30) Foreign Application Priority Data
Dec. 19, 2022 (EP) 22214409.9

(51) Int. Cl. G01J 3/46; G01J 3/02

(52) U.S. Cl. CPC G01J 3/463; G01J 3/0256; G01J 3/0272

(57) ABSTRACT

Disclosed herein is a hand-held device for spectrophotometry, including a) a housing with an opening for a light beam from a surface into the hand-held device b) an apparatus for determining the remission values of the light beam, and c) an interface for a mobile device providing a signal indicative for the remission values to the mobile device.

### FIELD OF THE INVENTION

The invention relates to a hand-held device for spectrophotometry, a hand-held spectrophotometer, a computer program product for spectrophotometry, a data storage for spectrophotometry and a system for providing a coating material of a specific color based on spectrophotometry.

### BACKGROUND OF THE INVENTION

Color is used in nearly every industry, in fact for different reasons. For example, color is used for safety (e.g. safety yellow), for identification (e.g. pipes coated blue indicate gas flowing through them), for branding (e.g. company color schemes) and for customer satisfaction (e.g. specific color for a body of a car). To avoid misleading or incorrect color schemes, color needs to be mixed very precisely.

In car body shops, for example, different colors are needed quickly and with high color precision. In order to provide such colors, a worker holds a spectrophotometer in front of an appropriate surface, thereby determining the color of the surface, in particular of the coating on the surface. Then, the worker programs the determined color into a color mixing machine, which produces a coating material of the determined color accordingly.

This, however, is error prone, slow and a major cost driver. In particular, the manual programming of the color mixing machine is very error prone due to typographical errors. Moreover, the format of the output of the spectrophotometer may be not in the same format as the demanded input by the color mixing machine and therefore, the worker needs to manually transcribe the color, color codes or the like, which is also very error prone. Furthermore, common spectrophotometers are hard to handle due to their size, and are ex-pensive due to their user interface.

Therefore, there is a need for an improved system for coating materials of a specific color. In particular, it would be advantageous to provide a more accurate and cheaper system.

### SUMMARY OF THE INVENTION

According to a first aspect of the invention, a hand-held device for spectrophotometry is provided, comprising a housing with an opening for a light beam from a surface into the hand-held device; an apparatus for determining the remission values of the light beam; and an interface for a mobile device providing a signal indicative for the remission values to the mobile device.

Thus, a hand-held device for spectrophotometry is provided, wherein a mobile device is used as a user interface (short: UI).

Spectrophotometry is a branch of electromagnet spectroscopy concerned with the quantitative measurement of the reflection or transmission properties of a material as a function of wavelength. Spectrophotometry uses photometers, known as spectrophotometers, that can measure the intensity of a light beam at different wavelengths, thereby determining colors of surfaces.

Preferably, the hand-held device comprises at least a housing with an opening, an apparatus for determining remission values and an interface for a mobile device.

The housing may be a container, a protective exterior, an enclosing structural element or the like. Preferably, the housing is designed to enable easier handling and/or to provide attachment points for internal mechanisms and/or to maintain cleanliness of the contents by shielding contaminations, such as dirt, dust, fluids and the like and/or to protect the contents from structural stress or physical, thermal, chemical, biological or radiational damages from surrounding environment and/or the like. The housing may be made of plastic, synthetic material, metal, ceramics or the like.

Preferably, the housing comprises at least one opening for a light beam, which is used by the apparatus to determine remission values of a surface, in particular of a coating material. The opening may have any kind of shape or form such as circular, triangular, rectangular or the like. The opening may also comprise a glass, a lens or the like, in particular to protect the interior of the housing.

Preferably, the housing may comprise additional features and/or content such an exterior for a mobile device, a flap for a battery compartment or the like. Preferably, the housing is designed to protect the apparatus for determining remission values and/or other content inside of the housing such as light sources, electric circuits or the like. Further, the housing may be designed in accordance with the Institute of Printed Circuits (IPC) or the like. Preferably, the housing is also designed for handling the hand-held device, e.g. by having ergonomic handles or the like. Preferably, the housing is dustproof and/or waterproof.

The apparatus for determining the remission values of the light beam is preferably within the housing. Preferably, the entire apparatus for determining the remission values is encapsulated by the housing. Herein, remission is preferably the reflection or back-scattering of light by a material or surface. Therefore, the apparatus for determining the remission values uses the reflection of a surface to determine its color. In particular, the apparatus for determining the remission values is used to determine a remission value of a color of a coating or a coating material or the like. Preferably, the apparatus for determining the remission values is or has the function of a photometer or a spectrophotometer. Preferably, the apparatus for determining the remission values has no user interface. Instead, the user interface for the apparatus is provided by a mobile device, which can be connected to the apparatus for determining the remission values via the interface.

Preferably, the apparatus for determining the remission values is a spectrophotometer. The spectrophotometer may have any kind of design, such as a single beam or double beam or the like. The spectrophotometer may also have any kind of architecture, such as single-angle or multi-angle. Preferably, the light and/or the camera of the spectrophotometer is adjustable, preferably between 0° and 90°, e.g. 30°, 45°, 60°, 90° angle or the like.

The interface for the mobile device may be any kind of interface such as a hardware interface, a software interface, a hybrid interface or the like. For example, the interface is provided by a Universal Serial Bus (short: USB) such as a USB 3.x or the like. Preferably, the interface is designed to provide at least a connection between the apparatus for determining the remission values and the mobile device. The interface may also be designed to transfer any data from the apparatus for determining the remission values to the mobile device and/or to provide power from the mobile device to the apparatus for determining the remission values. Therefore, it also proposed to power the apparatus for determining the remission values with the mobile device. However, in a preferred embodiment the apparatus for determining the remission values is powered by a power source of the hand-held device, such as a battery within a power compartment of the hand-held device or the like.

Hence, a hand-held device for spectrophotometry is provided, which uses a mobile device as user interface (short: UI). In particular, the hand-held device does not comprise any user interface or screen. The hand-held device, however, does comprise at least one interface, which is connectable to a mobile device, thereby allowing the mobile device to provide a user interface for hand-held device for spectrophotometry, in particular the apparatus for determining the remission values. Preferably, the mobile device comprises a computer program product as described herein, in particular to provide the correct color based on the remission values.

Preferably, the hand-held device for spectrophotometry and in particular the housing and/or the apparatus for determining the remission and/or the interface are designed to meet EX zone requirements. Alternatively and/or additionally, the hand-held device for spectrophotometry and in particular the housing and/or the apparatus for determining the remission and/or the interface are designed to meet ATEX zone classifications and/or NFPA classifications. In particular, the EX zone requirements and/or the ATEX zone classifications and/or the NFPA classifications are for a body shop or the like. Such requirements can be meet, for example, by using proper housing material and/or proper isolation for the electrical circuits and/or the like.

In a preferred embodiment, the housing comprises an exterior for holding the mobile device and/or a mechanism for coupling the mobile device to the housing.

Thus, the housing comprises at least one feature for holding the mobile device, in particular in such way that the hand-held device and the mobile device form a hand-held spectrophotometer as described below. For this, the housing may comprise a specific design such as an exterior rendering the negative form of the mobile device or the like. Additionally or alternatively, the housing may also comprise a mechanism for holding the mobile device. The mechanism may be a mechanical mechanism, an electrical mechanism, a magnetic mechanism or the like. For example, the mechanism has a clamp, a notch or the like, in particular to provide a click mechanism, which secures the mobile device at the hand-held device.

In a preferred embodiment, the apparatus for determining remission values is based on a multi-angle measurement system.

Thus, the light angle and/or the camera angle of the apparatus are adjustable, in particular between 0° and 90°. And to determine the remission values, at least two measurements with different angles are carried out, thereby accurately determining the remission values.

By using a multi-angle measurement system, the apparatus for determining remission values is designed to accurately precisely the color. By doing so, also metallic colors and the like can matched properly, in particular by determine the accurate color match.

In a preferred embodiment, the interface is on the same side of the housing as the exterior and/or the mechanism for coupling a mobile device to the housing.

Therefore, the hand-held device has a linear build-up and/or design. In particular, the opening is at the front of the housing and the interface, the exterior and/or the mechanism are at the back of the housing. This ensures a straight and linear design, allowing a compact hand-held device. Preferably, the hand-held device is designed similar to a camera, in particular like a camera.

In a preferred embodiment, the opening and the interface are on opposite sides of the housing, in particular front and back.

In a preferred embodiment, the housing provides a first handle and second handle, on opposite sides of the housing, in particular on the left side and on the right side of the housing.

The handles may be part of the housing or attached to the housing. Preferably, the handles are integral parts of the housing. Preferably, the handles have ergonomic shape, in particular for human hands. Preferably, the handles are on the right and on the left of the housing, whereas the opening is at the front and the exterior for the mobile device is at the back. Hence, the hand-held device has a similar build up to a hand-held camera.

In a preferred embodiment, the hand-held device also comprises a battery compartment and/or a light source and/or a camera and/or a transfer unit for measurement data.

Preferably, the battery compartment is inside the housing. The battery compartment may be designed for one or more batteries and/or rechargeable batteries. The battery compartment may also comprise a flap on the outside of the housing, in particular for changing the batteries without using any tool.

Preferably, the light source provides enough light, in particular remission, for the apparatus for determining the remission. Thus, the light source provides enough light for an accurate reading of the color.

Preferably, the transfer unit for measurement data is used to provide the measurement data from the apparatus for determining the remission values to mobile phone and/or cloud and/or color database as describes herein.

In a preferred embodiment, the housing also comprises a pin, in particular a pivotable pin, which is designed to hold and/or to secure the mobile device.

The pin may be part of the housing and/or made from the same material as the housing. Preferably, the pin is pivotable mounted to the housing and comprises the interface. Preferably, the pin is at the back of the housing.

In a preferred embodiment, the interface is designed to connect the apparatus for determining the remission values with a mobile device and/or to transfer data between the apparatus for determining the remission values and the mobile device.

Preferably, the interface is a wired and/or a hardware interface. Thus, the interface comprises an electric circuit. Preferably, the electric circuit of the interface is connected to the apparatus for determining the remission values. The electric circuit may also comprise an electric connector, in particular for the mobile device. Preferably, the electric connector of the hand-held device described herein fits an electric connector of the mobile device, such as USB 3.x or the like. In a more preferred embodiment, the interface is within the pin, in particular within the pivotable pin. Thus, the pin and/or the electric connector are adjustable and/or allow connection for different types of devices. Preferably, the pin and/or the connector can be extended or retracted to allow for different distances, in particular to attach the mobile device properly.

According to a second aspect of the invention, a hand-held spectrophotometer is provided, comprising a hand-held device, in particular as described herein, and a mobile device, which is connected to the hand-held device via the interface for a mobile device. In particular, the hand-held device and the mobile device together form a spectrophotometer.

Thus, a mobile device is used as a user interface for a hand-held spectrophotometer. In particular, the mobile device provides a much more stable and robust interface. Moreover, most mobile devices are much cheaper than common user interfaces for spectrophotometer and therefore, the hand-held spectrophotometer proposed herein is also much cheaper than common spectrophotometer.

The mobile device can be any kind of computer, in particular small enough to hold and operate in the hand of a user. Preferably, the mobile device comprises a screen. The screen may be any kind of screen such as an LCD, OLED flat screen or the like. Preferably, the screen has a size between 3 inches and 20 inches, preferably between 4.5 inches and 10 inches. Preferably, the screen provides a touchscreen interface with digital buttons and/or a keyboard. The mobile device may also comprises physical buttons and/or a physical keyboard. Preferably, the mobile device can connect to the Internet and/or interconnect with other devices such as a cloud and/or a data storage as described herein. The mobile device may be a mobile computer, a tablet computer, a hand-held PC, a mobile phone, a camera phone, a smartphone, a phablets or the like. Preferably, the mobile device is a smartphone. Preferably, the mobile is designed to run a computer program product as described herein.

According to a third aspect of the invention, a data storage for spectrophotometry is provided, comprising a color database having a plurality of data about different colors, wherein the color data base is designed to communicate with a hand-held spectrophotometer as described herein and/or a machine for providing a coating material, in particular as de-scribed herein.

The data storage may be based on a file system or hosted on a computer cluster or a cloud storage. Preferably, the data storage is a cloud or cloud-based. Preferably, the data storage is designed to determine color codes or color values based on remission values. For example, the apparatus for determining the remission value of the hand-held spectrophotometer determines the remission value for a certain coating. The remission value is then transferred to the mobile device and send to the data storage. The data storage may comprise a look-up table and an algorithm to determine a color code and/or color value having the closest match to the remission value. This color code and/or color value is then send to the color mixing machine and/or send to the mobile device or the like. If the color code is sent to the mobile device, the mobile device can display the color code for a user.

Preferably, the data storage and/or the color database may be a centralized or decentralized database or the like. A centralized database is a database that is located, stored, and maintained in a single location, e.g. a computer or a server. A decentralized database splits the workload up among multiple machines and uses sophisticated algorithms to balance the incoming and outgoing requests for the best response time, e.g. a cloud running on a plurality of servers. Preferably, the data storage and/or the color database is within a cloud and/or are cloud-based. Preferably, the color database is within the cloud of the data storage. Preferably, the color database comprises a plurality of color codes and/or color values. The color codes and/or color values may be standardized or unique.

According to a fourth aspect of the invention, a computer program product is provided, comprising instructions, which, when the program is executed by a computer, causes the computer to provide a visualization of at least one of: remission values provided by a hand-held device for spectrophotometry, particular as described herein; and/or an origin of a light beam shone into a hand-held device for spectrophotometry, in particular as described herein.

Preferably, the computer program product is form of an app. Preferably, the computer program product is designed for the mobile device. Preferably, the computer program product connects the spectrophotometer with a data storage, in particular to determine color codes, preferably of a coating.

In a preferred embodiment, the computer program product comprises instructions, which, when the program is executed by a computer, causes the computer to determine a color value based on the remission value, in particular based on a color data base/the color data base; and/or to provide the remission values or the color values directly to a color machine.

In a preferred embodiment, the computer program product comprises instructions, which, when the program is executed by a computer, causes the computer to communicate with a color data base for spectrophotometry, in particular as described herein, in order to identify a specific color and/or to provide data about a specific color, in particular to a color machine, preferably as described herein.

According to a fifth aspect of the invention, a system, in particular for a body shop, is provided, comprising a hand-held spectrophotometer as described herein and/or a data storage as described herein and/or a machine for providing a coating material of a specific color based on the spectrophotometry.

The machine for providing a coating material can be any kind of mixing machine. Preferably, the machine is designed to provide coating material in different colors. Preferably, the machine is a color mixing machine. Preferably, the color mixing machine provides a color and/or coating material for cars, in particular for car bodies.

The coating material can be any kind of coating material such as pure metals, metals, alloys, ceramic, ceramic oxide, cermets, pseudo alloys, paint, lacquer, plastic, hybrid dispersion, resin, acrylic resin, automotive coat, primer, base coat, clear coat or the like. The coating material may also consist of one coating technology or several different coating technologies, such as solvent-borne and/or water-borne polyurethanes and/or monocoat systems.

Preferably, the machine comprises at least an user interface (short: UI) and/or an interface for a data storage as described herein and/or a computer program product as described herein. The may machine may also comprise a control unit.

It shall be understood that the methods and systems as described above and the computer program product as described above have similar and/or identical preferred embodiments, in particular, as defined in the respective dependent claims.

It shall also be understood that a preferred embodiment of the present invention can also be any combination of the dependent claims or above embodiments with a respective in-dependent claim.

It shall also be understood that any connection of units or systems herein is to be under-stood as a data connection or data communication system that transfers, e.g. sending and receiving, data between the units and/or systems, e.g. a wire, a bus, a circuitry or the like. However, the data communication may also be wireless.

These and other aspects of the present invention will be apparent from and elucidated with reference to the embodiments described hereafter.

### BRIEF DESCRIPTION OF THE DRAWINGS

In the following drawings:

FIG. 1A shows schematically and exemplarily a hand-held device for spectrophotometry in a side view.

FIG. 1B shows schematically and exemplarily a hand-held spectrophotometer in a side view.

FIG. 2 shows schematically and exemplarily a system for providing a coating material of a specific color based one a spectrophotometry.

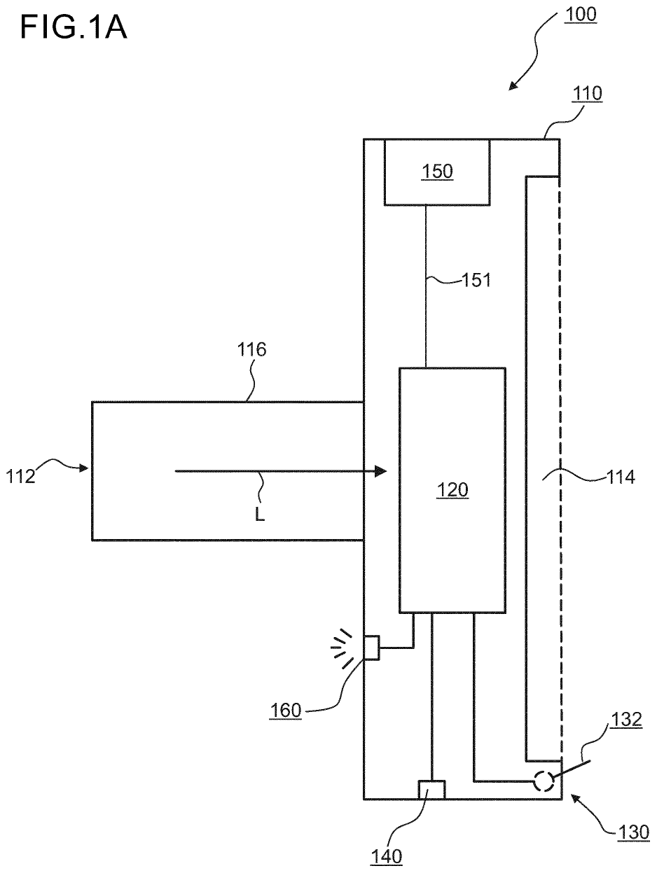

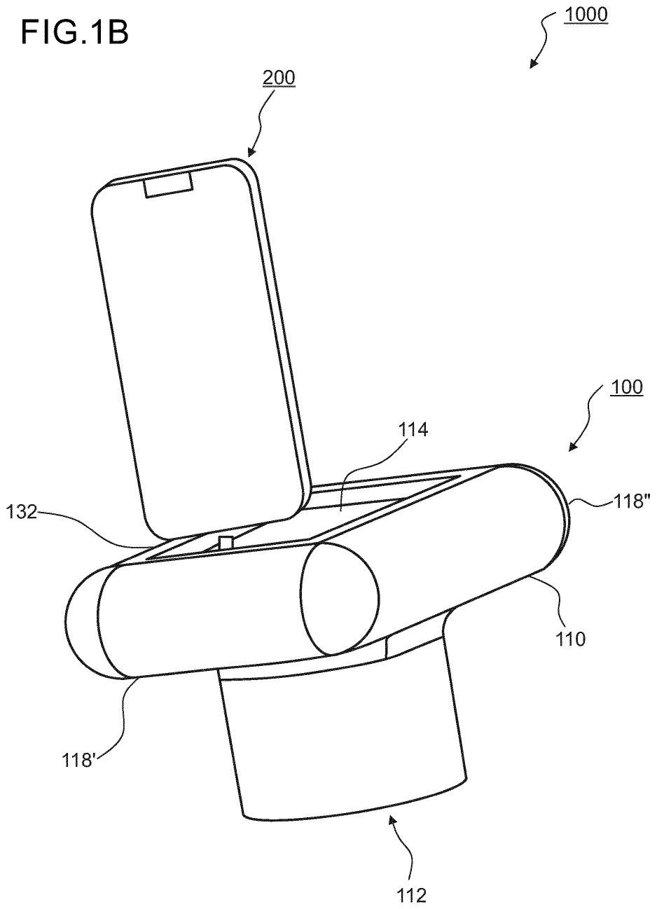

FIG. 1A shows schematically and exemplarily a hand-held device 100 for spectrophotometry in a side view. The hand-held device 100 comprises a housing 110, an apparatus 120, an interface 130, a utility interface 140 and a battery compartment 150.

The housing 110 may be made of plastic, synthetic material, metal, ceramics or the like. Preferably, the housing 110 encapsulates the entire apparatus 120 for determining the remission values. The housing 110 comprises at least one opening 112 for a light beam, in particular a light beam form a surface of a coating material. The opening 112 is so designed that the light beam can reach the apparatus 120 inside the hand-held device 100. The housing also comprises an exterior 114 for holding a mobile device. Preferably, the exterior 114 is so designed that the mobile device can be clicked or clamped into the exterior 114. The housing may also comprises other exteriors 116, e.g. for optics like lenses or the like. Furthermore, the housing may also comprise a mechanism for locking the mobile device with the housing 110 or any other part of the hand-held device 100, thereby locking the mobile device to the hand-held device 100.

Preferably, the apparatus 120 is encapsulated by the housing 110. In particular, the apparatus 120 is designed to measure remission values of a light beam. Preferably, the remission values are provided to a mobile device, in particular the mobile device within the exterior, via an interface 130.

Preferably, the interface 130 is a hardware interface. In particular, the interface is designed to transfer data, in particular the remission values, between the apparatus 120 and the mobile device, in particular the mobile device within the exterior. Preferably, the interface 130 is within a rotatable or pivotable pin or the like. To connect the mobile device with the apparatus, the pin can be fold out. Then, the mobile device can be plugged to the pin. Afterwards, the mobile device is rotated or pivoted into the exterior 114 using the pivotable pin. This way, the pin 132 has two functions, to electrically connect the mobile device with the apparatus and to guide the mobile device into the exterior 114 of the housing 110.

The mobile device may also comprises a computer program product as described herein, preferably an application program (short: app). Thus, the mobile device can be used as a user interface (short: UI) for the hand-held device 100, in particular the apparatus 120. The hand-held device 100 together with the mobile device forms a hand-held spectrophotometer as described herein or shown in FIG. 1B.

The hand-held device 100 may also comprise a utility interface 140 such as a data storage interface or the like. The additional interface 140 may be a hardware interface or a software interface or the like. The additional interface 140 may be wired or wireless. Preferably, the additional interface 140 is for a data storage as described herein or any kind of cloud service. The utility interface 140 may also be used to communicate with the mobile device or even to provide a signal indicative for the remission values to the mobile device.

The hand-held device 100 may also comprise a battery compartment 150 to power the apparatus 120, in particular via a wire 151. In another embodiment, the apparatus 120 may be powered by the mobile device, in particular by the battery of the mobile device, preferably via the pin 132 or another connection, such as another pin or a wireless connection.

The hand-held device 100 may also comprise a light source 160 such as an LED or the like. The light source 160 is designed to emit a specific light for illuminating a surface S and/or coating material C, thereby creating the light beam L for the apparatus 120.

FIG. 1B shows schematically and exemplarily a hand-held spectrophotometer 1000 in a side view. The hand-held spectrophotometer 1000 comprises a hand-held device 100, as shown in FIG. 1A, and a mobile device 200. The mobile device 200 is plugged into the hand-held device 100 via the pin 132. The pin 132 is pivotable so that the mobile device may be rotated or folded into the exterior 114 of the hand-held device 100.

The housing 110 also comprises an opening 112 at the front, an exterior 144 at the back and handles 118′, 118″ at the sides. Preferably, the pin 132 is one the same side of the housing 110 as the exterior 114, in particular on the back. Therefore, the opening 112 and the pin 132 are on opposite sides of the housing 110. Also, there is one handle 118′, 118″ on each side of the housing 110. Thus, there is a first handle 118′ on one side of the housing 110 and a second handle 118″ on the other side of the housing 110. Thus, the housing 110 provides a shape of a common camera.

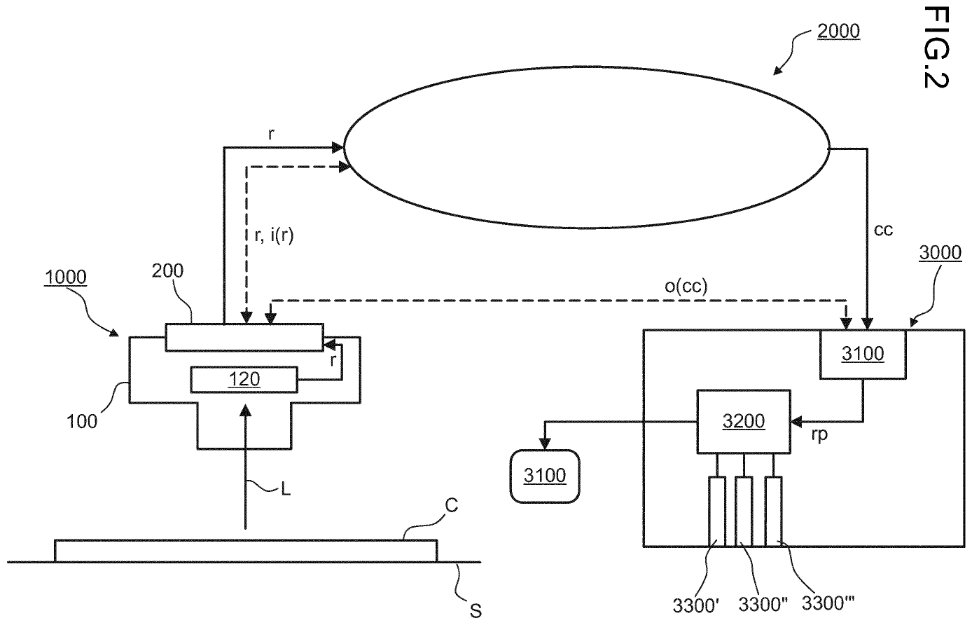

The mobile device 200 comprises a computer program product as described herein, for example an app for determining a color code or color value of a coating material. The functionality of the computer program product is described below in detail and with reference to FIG. 2.

FIG. 2 shows schematically and exemplarily a system 1000, 2000, 3000 for providing a coating material 3100 of a specific color based on a spectrophotometry.

The system 1000, 2000, 3000 comprises a hand-held spectrophotometer 1000, a data storage 2000 and a machine 3000. The machine 3000 is designed to provide coating material 3100 of a specific color. Thus, the machine is a color mixing machine.

For example, a body of car is to be repaired. For this, a coating material 3100 of a specific color is needed. In this case, the hand-held spectrophotometer 1000 is guided over the surface S of the body and the remission values r of the coating material C of the body are determined via the apparatus 120 of the hand-held spectrophotometer 1000. The remission values r are provided to the mobile device 200, in particular to the software application on the mobile device 200.

In one embodiment, the remission values are send to cloud-based color data base 2000 by the mobile device 200. The cloud-based color data base 2000 determines the closest match of color for the remission values r and sends a respective color code cc to the machine 3000. Based on the color code cc, a control unit 3100 of the machine 3000 determines a specific recipe rp. The recipe rp is provided to a mixing unit 3200, which produces a coating material in accordance with the recipe rp, thereby providing a coating material 3100 of a specific color, in particular a color matching the color of the coating material already on the body. To fulfil the recipe, the mixing unit 3200 may use material of different type and/or color 3300′, 3300″, 3300″ depending on the coating material 3100 to be provided.

In another embodiment, the remission value r and/or corresponding value i(r) are communicated between the mobile device 200 and the cloud-based color data base 2000. For example, the mobile device 200 sends the remission values r to the cloud-based color data base 2000 and the cloud-based color data base 2000 answers with a corresponding color code cc or the like. The mobile device 200 then displays a color corresponding to color code cc. The user of the mobile device 200 may then decide to proceed further or not, by sending an order o(cc) to the machine 3000, including the color code cc.

Thus, a cloud-based system is provided which may be easily installed or implemented in already existing workshops such as body shops and the like. Nearly every existing work-space having a color mixing machine may be upgraded this ways.

Although in the above-described embodiments reference was made to a hand-held device in a body shop, it will be understood that the method and/or system may be used for other purposes such as paint shops, varnishing shops or the like.

Even if in the above-described embodiments some functions have been described only with respect a specific unit, the same functions may be applicable to other units or a plurality of units.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items or means recited in the claims. The mere fact that certain measures are recited in mutually different dependent claims does not indicate that a combination of these measures cannot be used to advantage.

Procedures like the determining of a color value, providing of a color code, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a classical computing system. Preprocessing units or processing units or generating units may include a general purpose processor and may also include a field programmable gate array (FPGA), an application specific integrated circuit (ASIC), or any other specialized circuit. Any memory or database may be a physical system memory or a physical system database, which may be volatile, non-volatile, or some combination of the two. The term “memory” or “database” may include any computer-readable storage media such as a non-volatile mass storage. If the computing system is distributed, the processing and/or memory capability may be distributed as well. The computing system may include multiple structures as “executable components”. The term “executable component” is a structure well understood in the field of computing as being a structure that can be software, hardware, or a combination thereof. For instance, when implemented in software, one of ordinary skill in the art would under-stand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other in-stances, structures may be hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well under stood by those of ordinary skill in the art of computing, whether implemented in software, hardware, or a combination. Any embodiments herein are described with reference to acts that are performed by one or more pre-processing units and/or processing units of the computing system. If such acts are implemented in software, one or more processors direct the operation of the computing system in response to having executed computer-executable instructions that constitute an executable component. Computing system may also contain communication channels that allow the computing system to communicate with other computing systems over, for example, network. A “network” is defined as one or more data links that enable the transport of electronic data between computing systems and/or mod-ules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that at least parts of the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, main-frame computers, mobile telephones, PDAs, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program mod-ules may be located in both local and remote memory storage devices. The method may be also performed within an enterprise resource planning.

Those skilled in the art will also appreciate that at least parts of the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

1. A hand-held device for spectrophotometry, comprising:
a housing with an opening for a light beam from a surface into the hand-held device;
an apparatus for determining the remission values of the light beam; and
an interface for a mobile device providing a signal indicative for the remission values to the mobile device.

2. The hand-held device according to claim 1, wherein
the housing comprises at least one of:
an exterior for holding a mobile device; and/or
a mechanism for coupling a mobile device to the housing.

3. The hand-held device according to claim 1, wherein
the apparatus for determining remission values is based on a multi-angle measurement system.

4. The hand-held device according to claim 1, wherein
the interface is on the same side of the housing as the exterior and/or a locking mechanism for coupling a mobile device to the housing.

5. The hand-held device according to claim 1, wherein
the opening and the interface are on opposite sides of the housing.

6. A hand-held device according to claim 1, wherein
the housing provides a first handle and second handle, on opposite sides of the housing.

7. The hand-held device according to claim 1, wherein
the apparatus comprising at least one of:
a battery compartment;
a light source;
a camera; and
a transfer unit for measurement data.

8. The hand-held device according to claim 1, wherein
the housing comprises a pin, which is designed to hold the mobile device.

9. The hand-held device according to claim 1, wherein
the interface is designed for at least one of:
connecting the apparatus for determining the remission values with a mobile device; and/or
transferring data between the apparatus for determining the remission values and the mobile device.

10. A hand-held spectrophotometer, comprising:
the hand-held device according to claim 1; and
a mobile device, which is connected to the hand-held device via the interface for a mobile device.

11. A data storage for spectrophotometry, comprising:
a color database having a plurality of data about different colors, wherein
the color data base is designed to communicate with the hand-held spectrophotometer according to claim 10 and optionally to a machine for providing a coating material.

12. A computer program product comprising instructions, which, when the program is executed by a computer, causes the computer to provide a visualisation of at least one of:
remission values provided by a hand-held device for spectrophotometry; and/or
an origin of a light beam shone into a hand-held device for spectrophotometry.

13. The computer program product according to claim 12, further comprising instructions, which, when the program is executed by a computer, causes the computer
to determine a color value based on the remission value; and/or
to provide the remission values or the color values directly to a color machine.

14. The computer program product according to claim 12, further comprising instructions, which, when the program is executed by a computer, causes the computer:
to communicate with a color data base for spectrophotometry, to identify a specific color; and/or
to provide data about a specific color.

15. A system, comprising:
the spectrophotometer according to claim 10; and/or
a data storage for spectrophotometry comprising:
a color database having a plurality of data about different colors, wherein
the color data base is designed to communicate with the spectrophotometer and optionally to a machine for providing a coating material; and/or
optionally: a machine for providing a coating material of a specific color based on the spectrophotometry.

16. The hand-held device according to claim 8, wherein the pin is a pivotable pin.
